(19) United States
(12) Patent Application Publication
(10) Pub. No.: US 2017/0370300 A1
(43) Pub. Date: Dec. 28, 2017

(54) Method for Operating a Control Component of an Air Mass Flow Rate Controller and Control Component of an Air Mass Flow Rate Controller

(71) Applicant: Continental Automotive GmbH, Hannover (DE)

(72) Inventors: Rainer Johannes MONTIGNY, Bad Soden (DE); Raoul MOGE, Villingen (DE)

(21) Appl. No.: 15/536,802

(22) PCT Filed: Dec. 15, 2015
(86) PCT No.: PCT/EP2015/079797

§ 371 Date: Jun. 16, 2017

(30) Foreign Application Priority Data
Dec. 19, 2014 (DE) 10 2014 226 723.4

(51) Int. Cl. F02D 11/10; F02D 9/10; F02D 41/00

(52) U.S. Cl. CPC F02D 11/106; F02D 41/0002; F02D 9/105; F02D 2041/001; F02D 2200/0406; F02D 2011/101

(57) ABSTRACT

A method for operating a control component of an air mass flow rate controller for a drive machine of a motor vehicle, with which an actuator moves a control element into a target position and the position of the control element is detected by a sensor element in communication with a controller. The method includes: switching, in a rest mode, the actuator to a de-energized state; detecting, by the sensor element, the position of the control element indirectly or directly; and driving, by the controller, the actuator to correct the position of the control element in the event of a detected change of the position of the control element.

### CROSS-REFERENCE TO RELATED APPLICATIONS

This is a U.S. national stage of application No. PCT/EP2015/079797, filed on 15 Dec. 2015, which claims priority to the German Application No. 10 2014 226 723.4 filed 19 Dec. 2014, the content of both incorporated herein by reference.

### BACKGROUND OF THE INVENTION

### 1. Field of the Invention

The invention relates to a method for operating a control component of an air mass flow rate controller for a drive machine of a motor vehicle, with which an actuator moves a control element into a target position and the position of the control element is detected by a sensor element. Furthermore, the invention relates to a control component of an air mass flow rate controller for a drive machine of a motor vehicle with a control element controlling a cross-section of a line, with an actuator for driving the control element, with a control unit for actuating the actuator and with a sensor element for detecting the position of the control element.

### 2. Related Art

Control components for air mass flow rate controllers of combustion engines and fuel cell systems and methods for the operation thereof are known, for example as throttle valve assemblies. The control unit is, for example, integrated within the control component or can be an engine control unit of the combustion engine. The actuator is often an electric servomotor. The sensor element detects the position of the control element and provides signals to the control unit. The control unit actuates the actuator depending on the signals of the sensor element until the control element has reached the intended position thereof.

In order to save actuator energy, a rest mode in which the current feed of the actuator is turned off, is already known. In such a rest mode, the air mass flow should be kept constant. It is a disadvantage of the known control component and the method for actuation thereof that in the rest mode the position of the control element is no longer monitored. However, the control element can still be moved from the intended position by ambient influences or vibrations, for example. However, this results in erroneous air mass flow rate control of the control component in the rest mode.

### SUMMARY OF THE INVENTION

An object of the invention is to solve the problem of developing a method that enables holding the control component in the intended position in the rest mode and has a particularly low energy requirement. Furthermore, a control component for an air mass flow is to be provided, with which a change of the air mass flow when the actuator is turned off can be detected in a timely manner.

The first problem may be solved, according to an aspect of the invention, by switching the actuator to the zero-current state when in a rest mode and by the sensor element detecting the position of the control element directly or indirectly and by the control unit driving the actuator to correct the position of the control element in the event of a detected change of the position of the control element.

With this arrangement, in the rest mode the sensor element monitors the position of the control element and passes the position to the control unit. As a result, in the event of an unintentional displacement of the control element the control unit can temporarily interrupt the rest mode and move the control element back to the intended position. With this arrangement, in the rest mode the actuator can be switched to the deenergized state to save energy and is only activated again if the control element has unintentionally moved out of position.

The second problem mentioned, namely the provision of a control component for an air mass flow with which a change of the air mass flow can be detected in a timely manner when the actuator is turned off, may be solved, according to an aspect of the invention, by implementing the sensor element to output an activation pulse when the actuator is turned off.

With this arrangement, when the actuator is turned off the sensor element is held in the active state. This enables the sensor element to detect an unintended displacement of the control element in a particularly timely manner and to activate the control unit by the activation pulse. The control unit can now interrupt the rest mode of the actuator and ensure that the control element is driven into the intended position.

The sensor element could, for example, detect the position of the control element directly. A particularly high accuracy of detection of the position of the control element can be simply achieved with particularly low build costs according to another advantageous development of the invention if the sensor element is disposed between the actuator and a gearbox coupled to the control element.

With this arrangement, the sensor element can detect the position of a drive shaft driving the gearbox in a simple manner.

According to another advantageous development of the invention, an activation pulse can be produced particularly simply if the sensor element comprises a Hall sensor. With this design, in addition the energy requirement of the sensor element is reduced to a minimum.

According to another advantageous development of the invention, the control component has a particularly simple structural design if the sensor element is disposed opposite a magnet that is disposed on a drive shaft of the actuator.

### BRIEF DESCRIPTION OF THE DRAWINGS

The invention can have numerous embodiments. To further illustrate the basic principle thereof, one of the embodiments is represented in the figures and is described below. In the figures:

FIG. 1 shows a control component of an air mass flow rate controller for a drive machine of a motor vehicle; and

FIG. 2 shows a method for actuating the control component in a rest mode.

### DETAILED DESCRIPTION OF THE PRESENTLY PREFERRED EMBODIMENTS

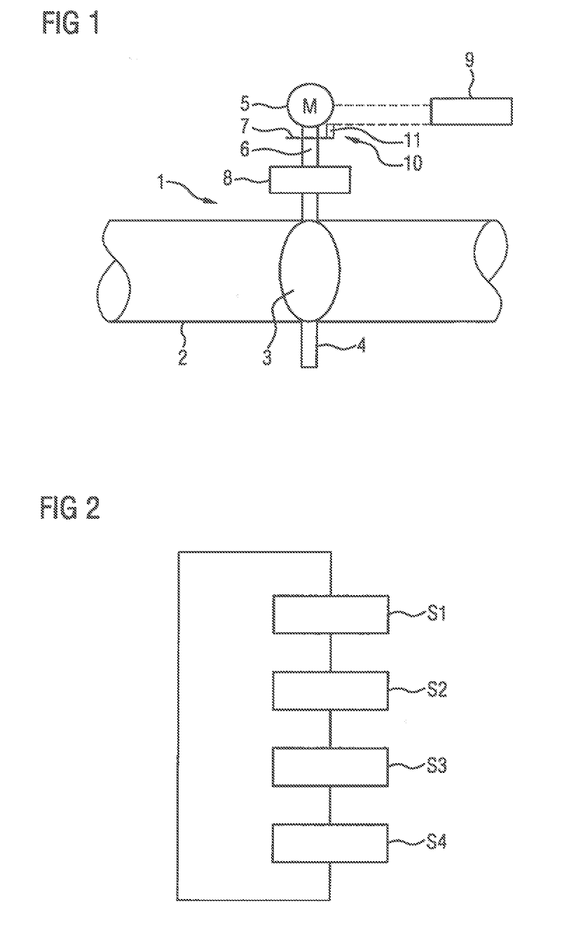

FIG. 1 shows a control component 1 of an air mass flow rate controller for a drive machine, which is not shown, of a motor vehicle. The drive machine can be a combustion engine or a fuel cell system. The control component 1 has a flap-shaped control element 3 disposed in a tube 2. The control element 3 is disposed on a shaft 4 and can be driven by an actuator 5 implemented as an electric servomotor. The actuator 5 has a drive shaft 6 on which a magnet 7 is disposed. A gearbox 8 is disposed between the drive shaft 6 and the shaft 4 of the control element 3. The gearbox 8 is preferably of a self-locking design, so that the drive shaft 6 cannot be displaced from the control element 3 side. Furthermore, the control component 1 has a controller 9 that is connected to a sensor element 10 implemented as a Hall sensor. In the represented exemplary embodiment with a Hall sensor 11, the sensor element 10 is disposed opposite the magnet 7 that is disposed on the drive shaft 6 and produces an electrical pulse during the movement of the magnet 7 that is forwarded to the controller 9. The controller 9 also actuates the actuator 5 to drive the control element 3.

If the controller 9 switches the actuator 5 to the deenergized state in a rest mode, changes of the position of the magnet 7 and thereby of the drive shaft 6, for example produced by vibrations, are detected by the sensor element 10. The pulse produced during this is used as an activation pulse for activating the actuator 5 in the rest mode.

FIG. 1 shows a method for actuating the actuator 5 from FIG. 1 that is switched into the deenergized state in the rest mode. In the step S1, a change of the position of the magnet 7 is detected by the sensor element 10 and an activation pulse is sent to the controller 9. In the step S2, the controller 9 activates the actuator 5, which then drives the control element 3 by means of the drive shaft 6. In the step S3, the newly set position of the actuator 5 and hence of the control element 3 is detected. Once the intended position of the control element 3 is reached, the actuator 5 is switched back to the deenergized state in a step S4.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-5. (canceled)

6. A method for operating a control component (1) of an air mass flow rate controller for a drive machine of a motor vehicle, with which an actuator (5) moves a control element (3) into a target position and the position of the control element (3) is detected by a sensor element (10) in communication with a controller (9), the method comprising:
switching, in a rest mode, the actuator (5) to a de-energized state;
detecting, by the sensor element (10), the position of the control element (3) indirectly or directly; and
driving, by the controller (9), the actuator (5) to correct the position of the control element (3) in the event of a detected change of the position of the control element (3).

7. A control component (1) of an air mass flow rate controller for a drive machine of a motor vehicle, comprising:
a control element (3) configured to control a cross-section of a line;
an actuator (5) configured to drive the control element (3);
a controller (9) configured to actuate the actuator (5); and
a sensor element (10) configured to detect the position of the control element (3),
wherein the sensor element (10) is configured to output an activation pulse when the actuator (5) is turned off.

8. The control component as claimed in claim 7, wherein the sensor element (10) is arranged between the actuator (5) and a gearbox (8) coupled to the control element (3).

9. The control component as claimed in claim 7, wherein the sensor element (10) comprises a Hall sensor (11).

10. The control component as claimed in claim 7, wherein the actuator (5) has a drive shaft (6) having a magnet (7) disposed thereon, and the sensor element (10) is arranged opposite the magnet (7).
